(19) United States
(12) Patent Application Publication
(10) Pub. No.: US 2011/0026286 A1
(43) Pub. Date: Feb. 3, 2011

(54) Transformer with Power Factor Compensation and A DC/AC Inverter Constructed Thereby

(76) Inventors: Wun-Chih LIU, Taipei city (TW); Szu-Hsien LIU, Taipei City (TW); Szu-Lin LIU, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/640,059

(22) Filed: Dec. 17, 2009

(30) Foreign Application Priority Data
Jul. 29, 2009 (TW) 098125580

(51) Int. Cl. H02M 7/42; H01F 27/29

(52) U.S. Cl. 363/140; 336/192

(57) ABSTRACT

A transformer with power factor compensation and a DC/AC inverter constructed thereby are presented. The power factor compensation transformer includes a primary winding, a secondary winding, and a power factor compensation capacitor bank, while the secondary winding having a coupling winding and a power factor compensation winding. The primary winding connects to a power grid in parallel, the coupling winding connects to an AC output port of a passive trigger type DC/AC inverter, and the power factor compensation winding serially connects with the power factor compensation capacitor bank. Besides, a triggered switch serially connecting with the power factor compensation winding and power factor compensation capacitor bank is provided when an inductor with air gap links the passive trigger type DC/AC inverter and the coupling winding. Consequently, a function of power factor correction is achieved.

### BACKGROUND OF THE INVENTION

1. Field of the Invention

The present invention relates to a DC/AC inverter, particularly to a DC/AC inverter having a transformer with a function of power factor compensation.

2. Description of the Related Art

Referring to FIG. 1, a conventional inverter with a known transformer 81 and a DC/AC inverting circuit 82 is shown. The said transformer 81 links the DC/AC inverting circuit 82 and a power grid for transforming and outputting power transmitted from the DC/AC inverting circuit 82. In detail, the transformer 81 includes a primary winding 811, a coupling winding 812 also called secondary winding, and a core 813 for the primary winding 811 and coupling winding 812 to wind around, so that electrical energy may be inductively transferred therethrough. Namely, one of the primary and coupling windings 811, 812 correspondingly induces an output current when an input current flows into the other one of them. The DC/AC inverting circuit 82 has a DC input terminal 821 for receiving DC power preferably generated by green energy technology, such as solar power generator, and an AC output terminal 822. The primary winding 811 of the transformer 81 couples to the power grid directly, while the coupling winding 812 electrically connects with the AC output terminal 822 of the DC/AC inverting circuit 82. Thereby, through the DC/AC inverting circuit 82, the DC power can be inverted into AC power outputted by the AC output terminal 822, and the transformer 81 transforms the AC power to generate an AC output voltage at the primary winding 811 to be injected into the power grid. Beside, please be noted that the generated AC output voltage is equal to a voltage of the power grid for the coupling purpose.

Generally, there are some disadvantages of the transformer 81 shown as the following. Owing to the direct connection between the primary winding 811 and the power grid, a current is generated in the primary winding 811, which includes an inductive component I₁ at the primary winding 811 easily leading to a great amount of reactive power. Thus, power factor of the outputted power of the conventional inverter is too low to comply with the user's requirement.

In order to solve the above-mentioned disadvantage, a parallel capacitor C shown in FIG. 1 is used. The parallel capacitor C electrically connects with the primary winding 811 in parallel to generate a current including a capacitive component I_{C} to compensate the inductive component I₁ of the current in the primary winding 811. Regarding to the parallel capacitor C, a specific capacitance of the parallel capacitor C is previously designed for the capacitive component I_{C} to be substantially equal in value but with 180 degrees out of phase relative to the inductive component I₁. Thus, power factor of the outputted power fed the power grid can be remarkably increased to improve the performance of the conventional inverter. Specifically, the parallel capacitor C is usually implemented by a set of capacitors in serial and/or parallel connections with each other to obtain the said specific capacitance. However, because the parallel capacitor C parallel to the primary winding 811 has to bear the voltage of the power grid and scales in capacitance of conventional high voltage capacitors are limited, the said specific capacitance may be difficult to be achieved in certain cases.

Referring to FIG. 2, another conventional inverter with the previous-introduced transformer 81 and a passive trigger type DC/AC inverting circuit 91 is illustrated. In comparison with the above-mentioned inverter, an air gap inductor 92 with serially connecting between the passive trigger type DC/AC inverting circuit 91 and transformer 81 is additionally used. With charging/discharging effect of the air gap inductor 92 and conversion provided by a plurality of thyristors such as silicon-controlled rectifier (SCR) switches of the DC/AC inverting circuit 91, a DC current offered by a DC power source keeps entering into the DC/AC inverting circuit 91 through a positive electrode of the DC/AC inverting circuit 91 and exiting by a negative electrode thereof. Furthermore, through the DC/AC inverting circuit 91, said DC current goes through the coupling winding 812 of the transformer 81 in alternative directions to complete DC/AC power transformation. Please be noted that either direction of the DC current when passing through the coupling winding 812 enforces energy output of the DC power source in a net output state. Regarding this inverter, in addition to the inductive component I₁ of the current in the primary winding 811 introduced in the previous inverter, an inductive component I₂ of a current that is generated by the passive trigger type DC/AC inverting circuit 9 and flows through the inductor 92 is further induced. With the said inductive component I₂ resulting in reactive power at a side of the transformer 81 connecting to the power grid, power factor of the outputted power of this conventional inverter and power quality thereof is even more lowered.

Furthermore, please be noted that the inductive component I₂ of the current in the inductor 92 is generated due to the trigger control of the passive trigger type DC/AC inverting circuit 91, and thus the inductive component I₂ is not in a sinusoidal waveform. Accordingly, even though the parallel capacitor C used in the previous inverter is applied, the inductive component I₂ can not be completely compensated, and the problem of low power factor still exists. Hence, there is a need of improvement in the conventional inverters.

### SUMMARY OF THE INVENTION

The primary objective of this invention is to provide a power factor compensation transformer of a DC/AC inverter to achieve a function of power factor correction.

The secondary objective of this invention is to provide a power factor compensation transformer and a DC/AC inverter constructed thereby with simplified circuit design.

Another objective of this invention is to provide a power factor compensation transformer and a DC/AC inverter constructed thereby to efficiently decrease space for installation and manufacturing cost.

The power factor compensation transformer in accordance with an aspect of the present invention comprises a core, a primary winding, a coupling winding, a power factor compensation winding, a power factor compensation capacitor bank, a triggered switch, and a current-limiting inductor. The primary winding is wired on the core in a direction and has a first connection port. The coupling winding is wired on the core and has a second connection port, with the coupling winding wired in the direction wherein the primary winding is wired. The power factor compensation winding is wired on the core in the direction wherein the primary winding and the coupling winding are wired. The power factor compensation capacitor bank serially connects with the power factor compensation winding. The triggered switch serially connects with the power factor compensation winding and power factor compensation capacitor bank. And, the current-limiting inductor serially connects with the power factor compensation winding, triggered switch, and power factor compensation capacitor bank.

The power factor compensation transformer in accordance with another aspect of the present invention comprises a core, a primary winding, a coupling winding, a power factor compensation winding, and a power factor compensation capacitor bank. The primary winding is wired on the core in a direction and having a first connection port. The coupling winding is wired on the core and having a second connection port, with the coupling winding wired in the direction wherein the primary winding is wired. The power factor compensation winding is wired on the core in the direction wherein the primary winding and the coupling winding are wired. And, the power factor compensation capacitor bank serially connects with the power factor compensation winding.

The DC/AC inverter in accordance with another aspect of the present invention comprises a passive trigger type DC/AC inverting circuit and a power factor compensation transformer. The passive trigger type DC/AC inverting circuit has an AC output port and an air gap inductor. The power factor compensation transformer has a primary winding, a coupling winding, a core, a power factor compensation winding, a power factor compensation capacitor bank, a current-limiting inductor, and a triggered switch. The primary winding has a first connection port for coupling to a power grid in parallel. The coupling winding has a second connection port coupling to the AC output port in parallel through the air gap inductor. The primary winding, coupling winding, and power factor compensation winding are respectively wired on the core in a direction. The power factor compensation winding, power factor compensation capacitor bank, current-limiting inductor and triggered switch are serially connected.

The DC/AC inverter in accordance with another aspect of the present invention comprises a DC/AC inverting circuit and a power factor compensation transformer. The DC/AC inverting circuit has a built-in oscillator and an AC output port. The power factor compensation transformer has a primary winding, a coupling winding, a core, a power factor compensation winding, and a power factor compensation capacitor bank. The primary winding has a first connection port for coupling to a power grid in parallel. The coupling winding has a second connection port coupling to the AC output port in parallel. The primary winding, coupling winding, and power factor compensation winding are respectively wired on the core in a direction. The power factor compensation winding and power factor compensation capacitor bank are serially connected.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic circuit illustrating a conventional DC/AC inverter with a used transformer;

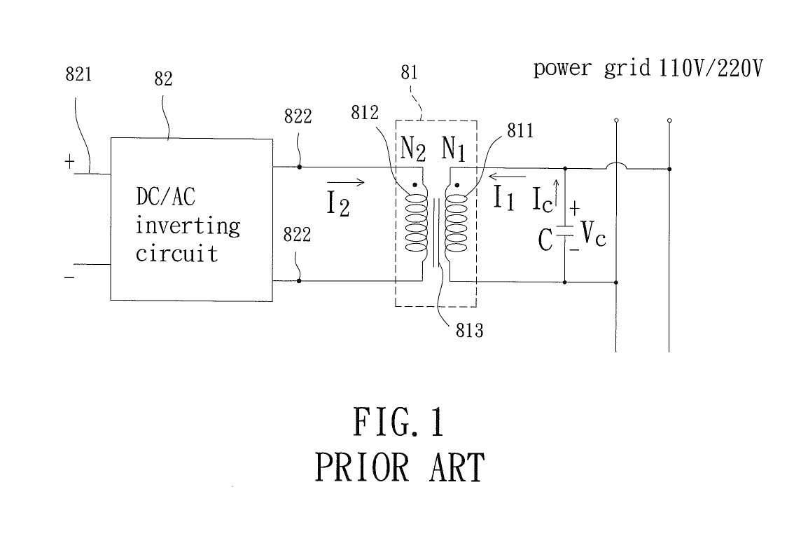

FIG. 2 is a schematic circuit illustrating a conventional passive trigger type DC/AC inverter with another used transformer;

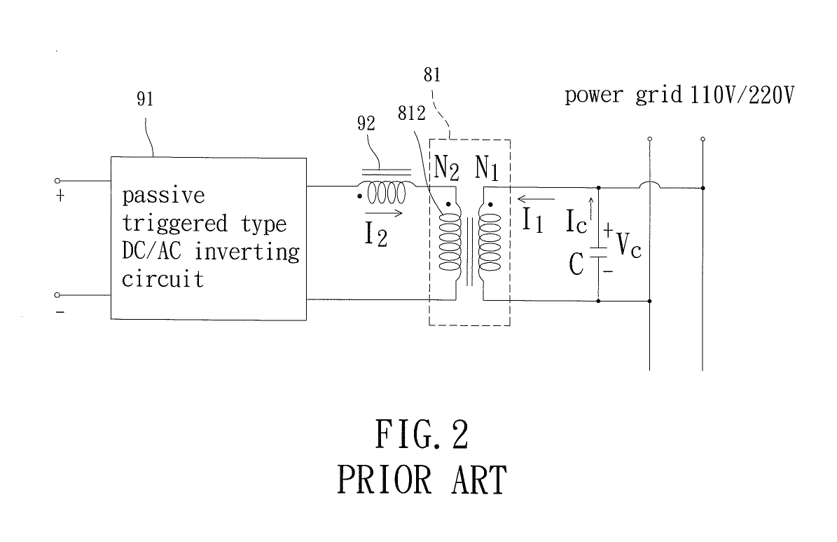

FIG. 3 is a schematic circuit illustrating a power factor compensation transformer and a DC/AC inverter constructed thereby in accordance with a first embodiment of the present invention;

FIG. 4 is a circuit diagram of a power factor compensation capacitor bank of the power factor compensation transformer in accordance with the first embodiment of the present invention;

FIG. 5 is a schematic circuit illustrating a power factor compensation transformer and a DC/AC inverter constructed thereby in accordance with a second embodiment of the present invention;

FIG. 6 is a schematic circuit illustrating a power factor compensation transformer and a DC/AC inverter constructed thereby in accordance with a third embodiment of the present invention.

In the various figures of the drawings, the same numerals designate the same or similar parts. Furthermore, when the term “first”, “second” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

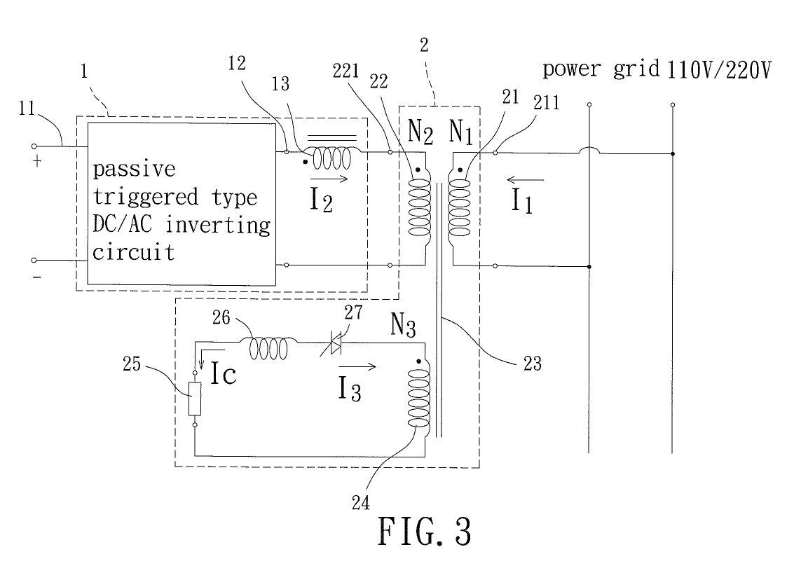

Referring to FIG. 3, a transformer with power factor compensation and a DC/AC inverter constructed thereby in accordance with a first embodiment of the present invention are shown. The DC/AC inverter includes a passive trigger type DC/AC inverting circuit 1 and a power factor compensation transformer 2 applied to the passive trigger type DC/AC inverting circuit 1. In detail, the passive trigger type DC/AC inverting circuit 1 has a DC input port 11, an AC output port 12, and an air gap inductor 13, and the power factor compensation transformer 2 has a primary winding 21, a coupling winding 22, a core 23, a power factor compensation winding 24, a power factor compensation capacitor bank 25, a current-limiting inductor 26, and a triggered switch 27. Being similar to the conventional inverter with the previous-introduced transformer 81 and passive trigger type DC/AC inverting circuit 91, there are also a current with an inductive component I₁ flowing through the primary winding 21 and another current with a inductive component I₂ flowing through the air gap inductor 13.

The above elements of the passive trigger type DC/AC inverting circuit 1 and power factor compensation transformer 2 are further illustrated as the following. The DC input port 11 receives DC power. The primary winding 21 has a first connection port 211 coupling to a power grid in parallel. The coupling winding 22 has a second connection port 221 coupling to the AC output port 12 in parallel for the AC output port 12 to feed the coupling winding 22 with an AC current. The core 23 forms a magnetic close loop for magnetic flux to flow therein, while the primary winding 21, coupling winding 22, and power factor compensation winding 24 are respectively and spirally wired on the core 23 in the same direction. Namely, the three windings 21, 22, 23 are all wired in the clockwise direction or in the counterclockwise direction on the core 23. The power factor compensation winding 24, power factor compensation capacitor bank 25, current-limiting inductor 26 and triggered switch 27 are serially connected to form a power factor compensation circuit.

Please refer to FIG. 3 again. When the power factor compensation winding 24 induces a current owing to operation of the primary winding 21 and coupling winding 22, a predetermined voltage is thereby built on the power factor compensation winding 24, and a compensation current I₃ is thus generated in the power factor compensation circuit. The compensation current I₃ will flow through the power factor compensation winding 24, and thus the magnetic flux φ flows in the core 23 can be shown as the following equation (1):

Φ∝(N₁I₁+N₂I₂+N₃I₃). (1)

In the equation (1), N₁, N₂, and N₃ respectively indicates numbers of turns of the primary winding 21, coupling winding 22, and power factor compensation winding 24, and turns N₁ is larger than turns N₃. Besides, because the primary winding 21 coupling to the power grid through the first connection port 211, a voltage V₁ of the power grid can be represented as the following equation (2):

$${V}_{1} = {N}_{1} \frac{d Φ}{d t} .$$

(2)
Through the above equations (1), (2), the voltage V₁ of the power grid can be further derived into the following form:

$${V}_{1} = {N}_{1} \frac{d ( {N}_{1} {I}_{1} + {N}_{2} {I}_{2} + {N}_{3} {I}_{3} )}{d t} . \qquad ( 3 )$$

And thus the following equation (4) is obtained.

∫V₁dt∝(N₁I₁+N₂I₂+N₃I₃). (4)

Specifically, the voltage V₁ of the power grid is controlled to be constant while the term of N₂I₂ is also a constant because the inductive component I₂ of the current in the air gap inductor 13 generated by the DC/AC inverting circuit 1 is fixed. Therefore, if the compensation current I₃ increases, the inductive component I₁ of the current in the primary winding 21 is accordingly reduced, and the reactive power caused by said inductive component I₁ will then decrease correspondingly. As a result, when the compensation current I₃ is controlled to increase, power factor of the outputted power of the present DC/AC inverter can be effectively raised. Particularly, because of coupling effect, the power factor compensation winding 24 induces an induced voltage having the same phase of the voltage V₁ of the power grid, and this results in the compensation current I₃, which can also be identified as a capacitive current I_{C} with a reverse direction relative to that of the compensation current I₃. The capacitive current I_{C} passes through the power factor compensation capacitor bank 25, so as to achieve power factor correction.

Furthermore, in order to eliminate the inductive component I₂ of the current in the air gap inductor 13, which also results in a low power factor of the outputted power of the present DC/AC inverter, the current-limiting inductor 26 and triggered switch 27 are used. Waveform of the inductive component I₂ is not sinusoidal because the inductive component I₂ is affected by a trigger angle of a thyristor in the passive trigger type DC/AC inverting circuit 1. Hence, a trigger angle of the triggered switch 27 is designed according to that of said thyristor in the passive trigger type DC/AC inverting circuit 1. In detail, the trigger angles of said thyristor and the triggered switch 27 are in the same half-cycle; that is, both of these two trigger angles are ahead of or behind a zero-crossover point. Thereby, the inductive component I₂ in the air gap inductor 13 can be eliminated. Consequently, the power factor compensation transformer 2 can generate capacitive reactive power provided by the power factor compensation capacitor bank 25 to compensate the inductive reactive power of the primary winding 21 and air gap inductor 13.

Furthermore, the triggered switch 27 is switched off only when the power factor compensation capacitor bank 25 is charged to a rating voltage thereof, while it may be switched on at any time even the power factor compensation capacitor bank 25 has not charged to the rating voltage. Besides, the current-limiting inductor 26 is used to limit a change rate of the capacitive current I_{C} flowing into or out of the power factor compensation capacitor bank 25, that is, the value of dI_{C}/dt, at the moment while the above mentioned triggered switch 27 is switched on. Specifically, regarding the current-limiting inductor 26, a problem in magnetic saturation is out of consideration, and thus an inductor in small size is acceptable for reducing weight and cost of the present DC/AC inverter.

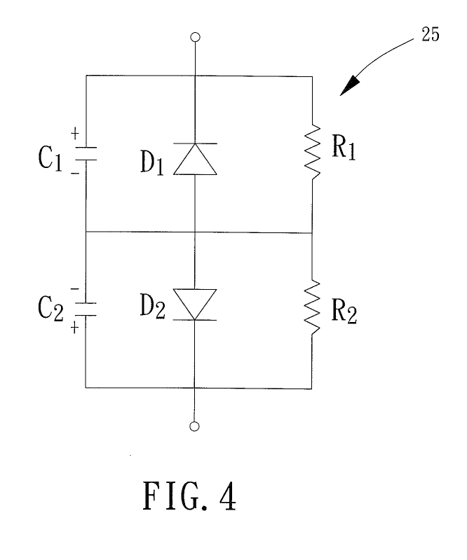

Please refer to FIG. 4, which shows a circuit of the power factor compensation capacitor bank 25 of the power factor compensation transformer 2. The power factor compensation capacitor bank 25 includes a first resistor R1, a second resistor R2, a first diode D1, a second diode D2, a first capacitor C1, and a second capacitor C2. The first resistor R1, first diode D1 and first capacitor C1 are connected in parallel, and the second resistor R2, second diode D2 and second capacitor C2 are also connected in parallel. Besides, the first diode D1 serially and reversely connects with the second diode D2, that is, a combination circuit of the first resistor R1, first diode D1 and first capacitor C1 and a combination circuit of the second resistor R2, second diode D2 and second capacitor C2 being in back-to-back connection, so as to prevent the two capacitors C1, C2 from damage caused by reverse bias. Furthermore, in a case where the capacitive current I_{C} is zero due to the shutdown of the DC power of the DC input port 11, the first and second resistors R1, R2 respectively connected with the first and second capacitors C1, C2 in parallel are used for discharging purpose of the first and second capacitors C1, C2. The two capacitors C1, C2 can be capacitors with small capacitance for lower cost. Moreover, the first and second resistors R1, R2 are provided for the two capacitors C1, C2 to release residual voltages.

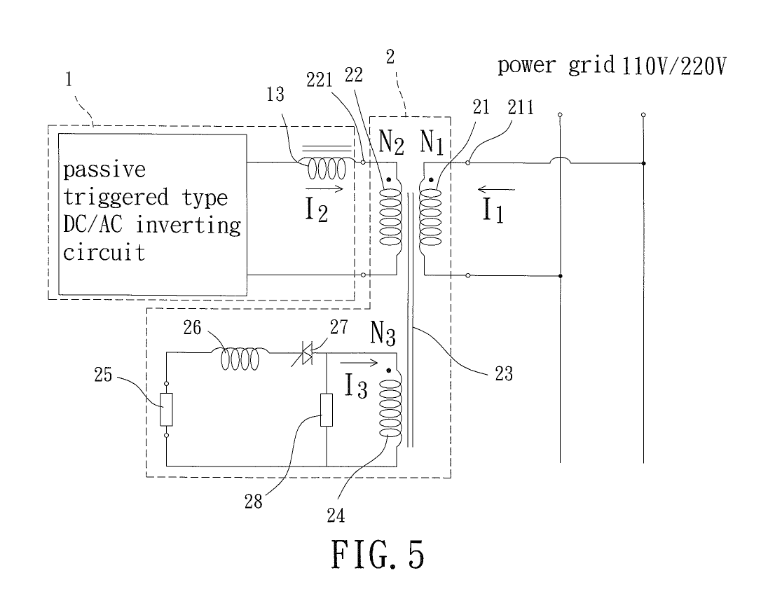

Now referring to FIG. 5, a transformer with power factor compensation and a DC/AC inverter constructed thereby in accordance with a second embodiment of the present invention are shown. In comparison with the structure of the first embodiment, an auxiliary power factor compensation capacitor bank 28 in a parallel connection with the power factor compensation winding 24 is added. A circuit of this auxiliary power factor compensation capacitor bank 28 is preferably identical to that of the power factor compensation capacitor bank 25. Resistance and inductance values of the elements in these two capacitor banks 25, 28 are designed to provide different current loops passing through the power factor compensation winding 24, so as to eliminate the reactive power of the primary winding 21 and air gap inductor 13. Specifically, the power factor compensation winding 24, power factor compensation capacitor bank 25, current-limiting inductor 26, triggered switch 27, and auxiliary power factor compensation capacitor bank 28 jointly form a power factor compensation circuit.

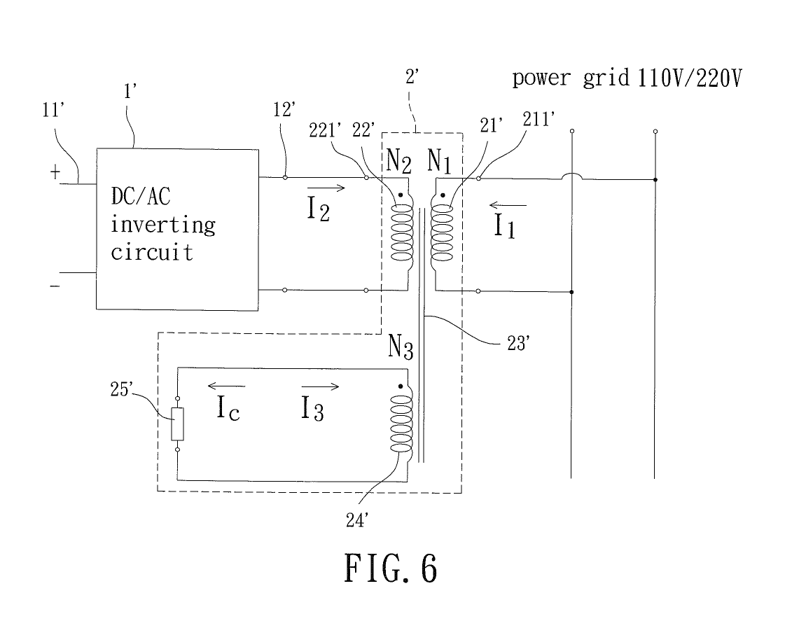

Please refer to FIG. 6 now. A transformer with power factor compensation and a DC/AC inverter constructed thereby in accordance with a third embodiment of the present invention are shown. In comparison with the structures of the first and second embodiments, the passive trigger type DC/AC inverting circuit 1 is replaced by a DC/AC inverting circuit 1′ with a built-in oscillator, and a power factor compensation transformer 2′ without the current-limiting inductor 26 and triggered switch 27 is applied to the DC/AC inverting circuit V. The DC/AC inverting circuit 1′ includes a DC input port 11′ and an AC output port 12′, with the DC/AC inverting circuit 1′ building an AC voltage by the built-in oscillator without the air gap inductor 13. Accordingly, the reactive power generated by the air gap inductor 13 is absent, and therefore the current-limiting inductor 26 and triggered switch 27 previously used is not necessary. Namely, the power factor compensation transformer 2′ in this embodiment only includes a primary winding 21′, a coupling winding 22′, a core 23′, a power factor compensation winding 24′, and a power factor compensation capacitor bank 25′. The structure of the power factor compensation transformer 2′ is similar to that of the power factor compensation transformer 2 in the first embodiment, except for that there are only the power factor compensation winding 24′ and power factor compensation capacitor bank 25′ to serially connect and form a power factor compensation circuit.

In sum, in addition to a function in power factor correction, there are some other functions achieved shown as the following.

First, required maximum voltages of the power factor compensation capacitor bank 25 and auxiliary power factor compensation capacitor bank 28 are largely lowered, which reduce the cost in manufacture indeed. In detail, the above function is achieved because the number of the turns N₃ is less than that of the turns N_{I}, and the power factor compensation winding 24 will not be affected by the voltage V₁ of the power grid. Besides, when the present DC/AC inverter is going to connect to a power grid with a voltage V₁ different from that of the original power grid, only the terms N₁ of the primary winding 21 should be changed instead of alteration in elements other than the primary winding 21.

Second, through control over the trigger angle of the triggered switch 27 of the power factor compensation transformer 2, the inductive component I₂ in an un-sinusoidal waveform can be effectively eliminated. Thereby, the induced current generated by the primary winding 21 is in a sinusoidal waveform and thus power quality is maintained.

Third, an efficient integration in functions of the power factor compensation transformer 2 is provided. The primary winding 21, coupling winding 22, and power factor compensation winding 24 are efficiently winded on the same core 23 of the power factor compensation transformer 2, and therefore additional requirements in space and cost are saved.

Finally, required space and cost in construction of the power factor compensation transformer 2 can be lower, because the power factor is greatly raised and the caliber of metal wire used for the primary winding 21 can be less.

Consequently, the power factor compensation transformer 2, 2′ can actually raise power factor and power quality, lower required cost in capacitors and manufacturing cost of a transformer and required space thereof, and provide an efficient integration in functions of a transformer. As a result, the power factor compensation transformer 2, 2′ is suitable for applications of a transformer in parallel connection with a power grid to provide a qualified electrical power.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A power factor compensation transformer, comprising:
a core;
a primary winding wired on the core in a direction and having a first connection port;
a coupling winding wired on the core and having a second connection port, with the coupling winding wired in the direction wherein the primary winding is wired;
a power factor compensation winding wired on the core in the direction wherein the primary winding and the coupling winding are wired;
a power factor compensation capacitor bank serially connecting with the power factor compensation winding;

2. The power factor compensation transformer as defined in claim 1 further comprising a triggered switch serially connecting with the power factor compensation winding and power factor compensation capacitor bank.

3. The power factor compensation transformer as defined in claim 2 further comprising a current-limiting inductor serially connecting with the power factor compensation winding, triggered switch, and power factor compensation capacitor bank.

4. The power factor compensation transformer as defined in claim 3 further comprising an auxiliary power factor compensation capacitor bank connecting with the power factor compensation winding in parallel.

5. The power factor compensation transformer as defined in claim 3, wherein a number of turns of the power factor compensation winding is less than a number of turns of the primary winding.

6. The power factor compensation transformer as defined in claim 3, wherein the power factor compensation capacitor bank comprises a first resistor, a second resistor, a first capacitor, a second capacitor, a first diode, and a second diode, with the first resistor, first capacitor, and first diode being connected in parallel, the second resistor, second capacitor, and second diode being connected in parallel, and a combination circuit of the first resistor, first diode, and first capacitor and a combination circuit of the second resistor, second diode, and second capacitor being in back-to-back connection.

7. The power factor compensation transformer as defined in claim 1, wherein a number of turns of the power factor compensation winding is less than a number of turns of the primary winding.

8. The power factor compensation transformer as defined in claim 1, wherein the power factor compensation capacitor bank comprises a first resistor, a second resistor, a first capacitor, a second capacitor, a first diode, and a second diode, with the first resistor, first capacitor, and first diode being connected in parallel, the second resistor, second capacitor, and second diode being connected in parallel, and a combination circuit of the first resistor, first diode, and first capacitor and a combination circuit of the second resistor, second diode, and second capacitor being in back-to-back connection.

9. A DC/AC inverter, comprising:
a passive trigger type DC/AC inverting circuit having an AC output port and an air gap inductor; and
a power factor compensation transformer having a primary winding, a coupling winding, a core, a power factor compensation winding, a power factor compensation capacitor bank, a current-limiting inductor, and a triggered switch, with the primary winding having a first connection port for coupling to a power grid in parallel, with the coupling winding having a second connection port coupling to the AC output port in parallel through the air gap inductor, with the primary winding, coupling winding, and power factor compensation winding being respectively wired on the core in a direction, and with the power factor compensation winding, power factor compensation capacitor bank, current-limiting inductor and triggered switch being serially connected.

10. The DC/AC inverter as defined in claim 9, wherein the power factor compensation transformer further comprises an auxiliary power factor compensation capacitor bank connecting with the power factor compensation winding in parallel.

11. The DC/AC inverter as defined in claim 9, wherein a number of turns of the power factor compensation winding is less than a number of turns of the primary winding.

12. The DC/AC inverter as defined in claim 9, wherein the power factor compensation capacitor bank comprises a first resistor, a second resistor, a first capacitor, a second capacitor, a first diode, and a second diode, with the first resistor, first capacitor, and first diode being connected in parallel, the second resistor, second capacitor, and second diode being connected in parallel, and a combination circuit of the first resistor, first diode, and first capacitor and a combination circuit of the second resistor, second diode, and second capacitor being in back-to-back connection.

13. A DC/AC inverter, comprising:
a DC/AC inverting circuit having a built-in oscillator and an AC output port; and
a power factor compensation transformer having a primary winding, a coupling winding, a core, a power factor compensation winding, and a power factor compensation capacitor bank, with the primary winding having a first connection port for coupling to a power grid in parallel, with the coupling winding having a second connection port coupling to the AC output port in parallel, with the primary winding, coupling winding, and power factor compensation winding being respectively wired on the core in a direction, and with the power factor compensation winding and power factor compensation capacitor bank being serially connected.

14. The DC/AC inverter as defined in claim 13, wherein a number of turns of the power factor compensation winding is less than a number of turns of the primary winding.

15. The DC/AC inverter as defined in claim 13, wherein the power factor compensation capacitor bank comprises a first resistor, a second resistor, a first capacitor, a second capacitor, a first diode, and a second diode, with the first resistor first capacitor, and first diode being connected in parallel, the second resistor, second capacitor, and second diode being connected in parallel, and a combination circuit of the first resistor, first diode, and first capacitor and a combination circuit of the second resistor, second diode, and second capacitor being in back-to-back connection.
